(19) United States
(12) Patent Application Publication
(10) Pub. No.: US 2012/0302268 A1
(43) Pub. Date: Nov. 29, 2012

(54) Short message service center (SMSC) message distributor

(76) Inventors: Paul Casto, Bowie, MD (US); Lewis Tuttle, Stevensville, MD (US)

(21) Appl. No.: 13/506,438

(22) Filed: Apr. 19, 2012

Related U.S. Application Data
(60) Provisional application No. 61/457,544, filed on Apr. 19, 2011.

(51) Int. Cl. H04W 4/14

(52) U.S. Cl. 455/466

(57) ABSTRACT

A method enabling a device the ability to maintain a personal distribution list (PDL), i.e., a group contact list, via manipulation of text messages sent over the SMS, with service homed on the SMSC. Each PDL is maintained on an SMSC affiliated with the list's originating device and is referenced with a trigger address, either particularly or implicitly defined. When an SMSC receives an SMS message destined to a trigger address, identifying a PDL, the SMSC copies the originally transmitted text message for every recipient in the list. The SMSC subsequently routes each duplicate text message to every address contained within the indicated PDL, via conventional SMS procedures. Syntax indicating list management operations (e.g., add, delete, list entries, and delete, synch, and/or tag entire list) may be indicated in the body of an SMS message addressed to the local address of the SMSC for list management capabilities.

This application claims priority from U.S. Provisional Appl. No. 61/457,544, entitled “short message service center (SMSC) Message Distributor” to Casto et al., the entirety of which is explicitly incorporated herein by reference.

### BACKGROUND OF THE INVENTION

1. Field of the Invention

This invention relates generally to telecommunications. More particularly, it relates to short message service messaging.

2. Background of Related Art

In 1990, the European Telecommunications Standards Institute (ETSI) published a standard for the first fully digital cellular communications system. This standard, now referred to as the Global System for Mobile Communications (GSM), has since grown to become the worlds' most widely utilized standard in mobile telephony.

A short message service (SMS), first launched in 1991, is among the many technological contributions included in the Global System for Mobile Communications (GSM). short message service (SMS) initially enabled bidirectional transmission of short alphanumeric text messages to and from a Short Message Entity (SME). A Short Message Entity (SME) is a communication device or system capable of sending and receiving short messages, e.g., a cellular telephone handset, a phone, or a computer-based communication system.

A maximum of 160 characters of text is permitted in a single SMS message. An SMS message is transmitted over a digital wireless network utilizing Code Division Multiple Access (CDMA) or Time Division Multiple Access (TDMA) access schemes.

FIG. 7 depicts an exemplary conventional SMS Network structure.

A short message service center (SMSC) 710 is an essential element in an SMS network 700. The short message service center (SMSC) 710 operates in a store-and-forward manner, to guarantee delivery of text messages to a Short Message Entity (SME) 770, e.g., a cellular telephone handset, a phone, or a computer-based communication system. The short message service center (SMSC) 710 includes a storage subsystem to store messages that are temporarily incapable of being transmitted to a destination device 770, e.g., when the destination device is inactive or outside of the service area of the SMS network 700. The short message service center (SMSC) 710 continues to forward undelivered messages to an appropriate destination address in intervals, until the designated device has become available, e.g., is turned on or has moved into the service area of the SMS network 700, and message receipt is confirmed. A short message service center (SMSC) 710 encompasses various interfaces to enable the receipt of short messages originating from a multitude of input mechanisms, e.g., Voice Mail Systems and/or Email Systems.

A Home Location Register (HLR) 720 includes a central database containing SMS subscriber information. The short message service center (SMSC) 710 queries the Home Location Register (HLR) 720 to determine which network is currently serving a mobile device. The short message service center (SMSC) 710 uses routing information supplied by the Home Location Register (HLR) 720 to successfully route a transmitted SMS message to an intended destination. The Home Location Register (HLR) 720 also discloses to the short message service center (SMSC) 710 whether or not a mobile device is currently available to receive messages. Accordingly, a Home Location Register (HLR) 720 advises the short message service center (SMSC) 710 when a previously inactive subscriber, initially incapable of receiving messages, has become available. Once the short message service center (SMSC) 710 receives notification of a subscriber's newfound availability, the short message service center (SMSC) 710 attempts delivery of a message previously stored due to transmission failure.

A Visitor Location Register (VLR) 730 is a database that temporarily maintains information regarding roaming wireless devices on the SMS network. The Visitor Location Register (VLR) 730 requests data from the Home Location Register (HLR) 720 regarding mobile stations that have entered a visited network, i.e., a network governing a geographical area outside the compounds of a Home Network, to which a subscriber is registered. Thus, a Visitor Location Register (VLR) 730 only contains information regarding subscribers currently present in the location area affiliated with the Visitor Location Register (VLR) 730. Data contained in the Visitor Location Register (VLR) 730 is used by the Mobile Switching Center (MSC) 740 to service visiting mobile stations.

A Mobile Switching Center (MSC) 740 is an element responsible for performing switching functions throughout the SMS network 700. The Mobile Switching Center (MSC) 740 routes information amongst SMS network elements, using routing information obtained from the Home Location Register (HLR) 720 and the Visitor Location Register (VLR) 730. The Mobile Switching Center (MSC) 740 acts as a medium, transferring short messages between a short message service center (SMSC) 710 and a mobile station (MS) 760. A Gateway Mobile Switching Center (G-MSC) serves as a point of contact between two individual SMS networks 700, allowing networks to send short messages amongst one another.

A Base Station Subsystem (BSS) 750 serves as an interface between the SMS network 700 and an SMS mobile subscriber 760. The Base Station Subsystem (BSS) 750 permits communication across an air interface, via transmission of short messages. Hence, the Base Station Subsystem (BSS) 750 allows a short message (SM) to be transmitted from the Mobile Switching Center (MSC) 740 and subsequently received on the wireless device 760.

FIG. 8 portrays an exemplary short message flow within a conventional short message service (SMS).

In operation, a short message service center (SMSC) 810 is the first recipient of an SMS message en route from an originating device 800 to a destination device 850. Upon receipt of a transmitted SMS message, the short message service center (SMSC) 810 queries the Home Location Register (HLR) 820 for routing information regarding the destination device designated in the SMS message. The Home Location Register (HLR) 820 responds to the short message service center (SMSC) 810 with routing information and the status of the destination device 850, e.g., active or inactive.

If the destination device 850 is active, the short message service center (SMSC) 810 forwards the transmitted message to the Mobile Switching Center (MSC) 830 on the SMS network. The Mobile Switching Center (MSC) 830 proceeds to query the Visitor Location Register (VLR) 840, requesting additional subscriber information and the performance of potential authentication requirements. The Mobile Switching Center (MSC) 830 receives subscriber information from the Visitor Location Register (VLR) 840 and forwards the transmitted short message to the intended destination device 850. The message is sent using a transfer protocol, e.g., Short Message Delivery Point to Point protocol (SMDPP). Subsequent to message transmission, the Mobile Switching Center (MSC) 830 transmits a delivery report back to the short message service center (SMSC) 810, indicating successful or unsuccessful message delivery. Upon request, the short message service center (SMSC) 810 will forward the delivery status of a transmitted SMS message to the originating Short Message Entity (SME) 800.

If the destination subscriber 850 is currently unavailable, e.g., it is turned off or outside of the service area of the SMS network, the short message service center (SMSC) 810 stores the transmitted SMS message for a later delivery attempt. In the presence of a failed message attempt or an unavailable subscriber, the short message service center (SMSC) 810 sends a message to the Home Location Register (HLR) 820, requesting to be notified once a device designated in a failed message becomes available. The Home Location Register (HLR) 820 then adds the address of the requesting short message service center (SMSC) 810 to a list of other short message service centers (SMSCs) also requesting notification upon activation of the indicated device 850 within the network. Once the destination device 850 becomes active, e.g., it is turned on or has moved into the service area of the SMS network, the Home Location Register (HLR) 820 notifies the short message service center (SMSC) 810. Upon notification, the short message service center (SMSC) 810 attempts to deliver a stored SMS message to the Mobile Switching Center (MSC) 830 serving the designated device 850. The short message service center (SMSC) 810 is provided verification upon successful delivery of an SMS message to an end user 850. Once verification of delivery is received, the short message service center (SMSC) 810 will no longer attempt any subsequent transmissions of the delivered message.

SMS elements are able to communicate with one another via Signaling System Number 7 (SS7) signaling protocols.

short message services (SMS) continue to gain in popularity, in part due to a growing emergence of SMS technology in wireless handheld devices. Currently, SMS is the most widely used data application in the world.

However, not all wireless devices, particularly older devices, are capable of acquiring internet access. As a result, legacy handsets do not have a means of easily sending text messages to a group of mobile devices. Alternatively, legacy handsets require entry of multiple addresses to a message to be sent, or require the same message to be sent several times with different addresses (depending on the handset). Though, the desire is simply to, e.g., ‘send a message to the family’ or ‘let the team know the game is cancelled’.

There are smart phone based applications that have the capability to maintain a group list and allow a communication device to send a text message to that list, but these applications are limited to certain classes of phone. Additionally, that approach does not take advantage of a simplified list management solution that enables a personal distribution list (PDL) to be shared amongst members of the list. Instead, each smart phone is required to program and maintain an individual copy of the personal distribution list (PDL), permitting possible synchronization issues.

While smart phones are gaining in popularity, the sale of feature phones still currently outnumbers the sale of smart phones. Hence, there remains a need for mobile service providers to appeal to the feature phone market.

### SUMMARY OF THE INVENTION

In accordance with the principles of the present invention, a personal distribution list (PDL) distributor for a short message service center (SMSC) comprises a trigger module, triggered by detection of a specific trigger address contained within a received short message, to identify a predefined personal distribution list (PDL) predefined within a personal distribution list database accessible to a short message service center (SMSC). A message duplicator module copies the received short message for each unique destination address within the identified personal distribution list to a plurality of uniquely destination-addressed short messages each containing a same payload. A transmitter transmits each of the plurality of uniquely destination-addressed short messages to respective destinations.

A method of broadcasting a single SMS message to a plurality of destinations in accordance with another aspect of the invention comprises receiving an SMS message addressed to a unique destination address associated with a desired personal distribution list. The received SMS message is duplicated for each of a plurality of destination addresses predefined in the desired personal distribution list. Each duplicate SMS message is configured according to a configuration characteristic predefined within the desired personal distribution list (PDL). Each duplicate SMS message is routed toward respective destinations using respective protocols predefined in the desired personal distribution list (PDL).

In accordance with yet another aspect, a short message service center (SMSC) broadcasts a single received SMS message to a plurality of destinations predefined in a personal distribution list (PDL) comprising a receiver to receive an SMS message addressed to a personal distribution list (PDL). A duplicator copies the received SMS message for each of a plurality of unique destination addresses predefined in the personal distribution list (PDL). A configuration module configures each duplicate message according to respective configuration characteristics predefined in the personal distribution list (PDL). A transmitter transmits each duplicate message to each respective destination address.

Still further, a method of performing list management on a personal distribution list (PDL) comprises receiving an SMS message addressed to an SMSC Management Code. A text field of the received SMS message is parsed for a valid personal distribution list (PDL) trigger address. The text field of the received SMS message is parsed for predefined list management syntax. An appropriate list management operation is performed on an indicated personal distribution list (PDL) upon validation of the PDL trigger address, and the predefined list management syntax contained within the received SMS message is identified. A confirmation SMS message is transmitted to an originating address.

In accordance with still another aspect of the invention, a short message service center (SMSC) performs list management on a personal distribution list (PDL). A receiver receives an SMS message addressed to an SMSC Management Code. A parser parses the SMS message for identification of a valid trigger address associated with predefined list management syntax. A list manager performs a list management operation requested in the received SMS message, and a transmitter transmits a confirmation SMS message to an originating address of the received SMS message.

### BRIEF DESCRIPTION OF THE DRAWINGS

Features and advantages of the present invention will become apparent to those skilled in the art from the following description with reference to the drawings, in which:

FIG. 1A depicts an exemplary short message flow, in accordance with the principles of the present invention.

FIG. 1B depicts an illustrative example of the format of a short message, in accordance with the principles of the present invention.

FIG. 2 depicts an exemplary process of broadcasting short messages to a personal distribution list (PDL) via a short message service (SMS), in accordance with the principles of the present invention.

FIG. 3 depicts an illustrative example of a personal distribution list (PDL) maintained in a database accessible by a short message service center (SMSC), in accordance with the principles of the present invention.

FIG. 4 depicts an illustrative example of a personal distribution list (PDL) with an implied trigger address, in accordance with the principles of the present invention.

FIG. 5 shows an illustrative exemplary outbox of an SMS application implementing the principles of the present invention.

FIG. 6 depicts an exemplary process of manipulating a personal distribution list (PDL) via the short message service (SMS), in accordance with the principles of the present invention.

FIG. 7 depicts an exemplary conventional SMS Network structure.

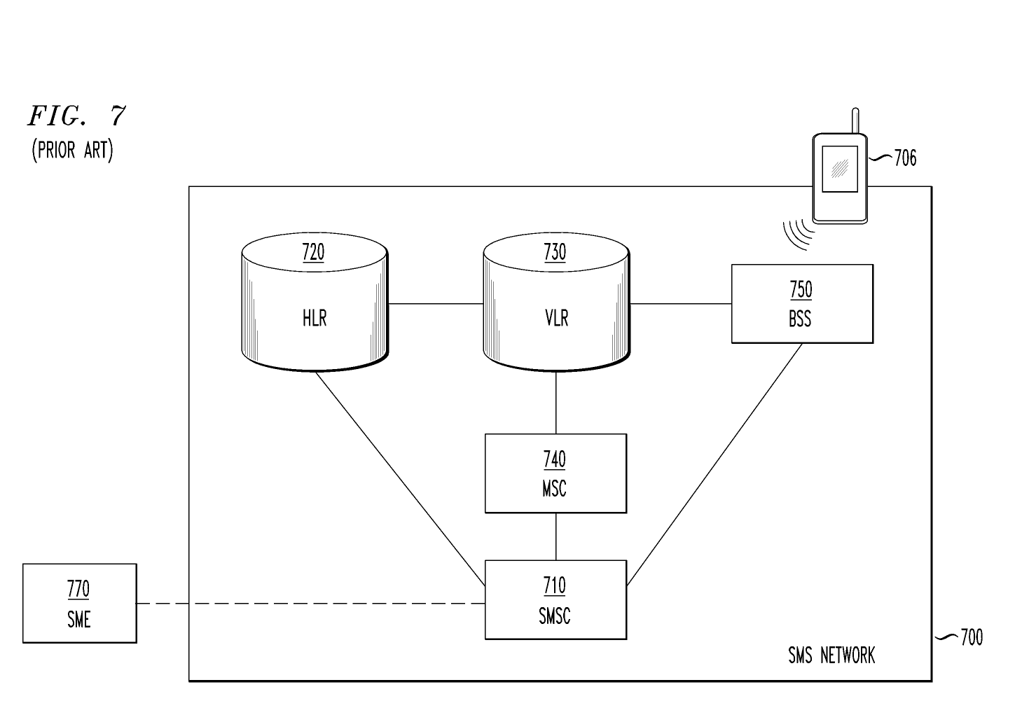

FIG. 8 portrays an exemplary short message flow within a conventional short message service (SMS).

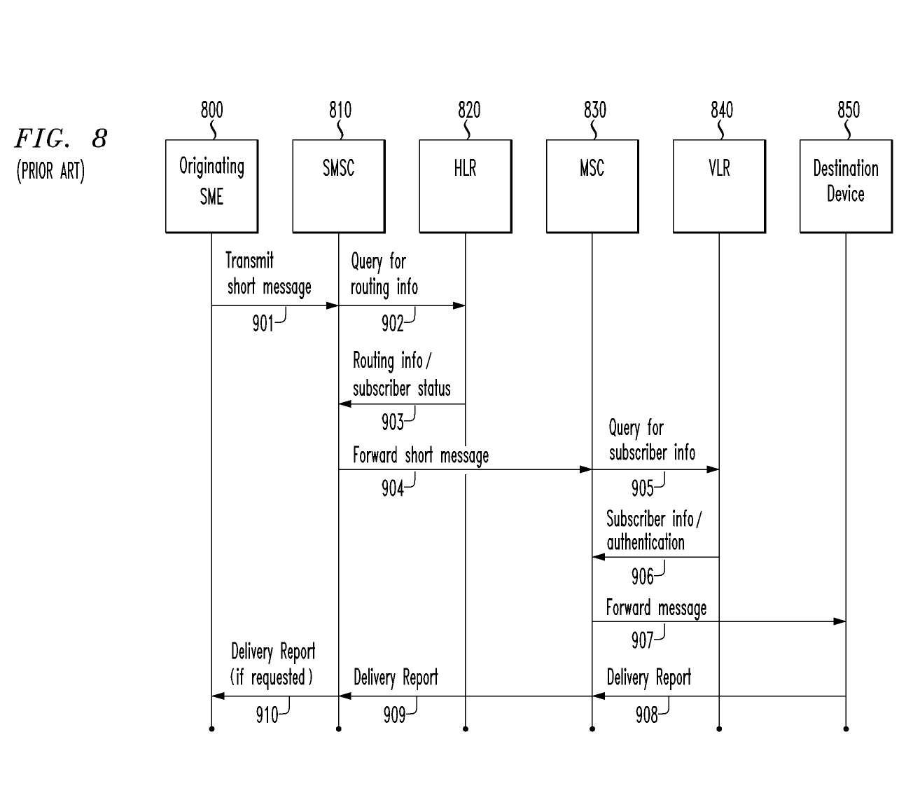

### DETAILED DESCRIPTION OF ILLUSTRATIVE EMBODIMENTS

The launch of smart phones has led to innovations supporting the ease of use of SMS applications. For instance, certain smart phones have the ability to maintain a personal distribution list (PDL), i.e., a group contact list, and allow a user to send an SMS message to that list. This ‘send to list’ application performed on certain smart phones requires internet access to establish a data session with an external system, for list management capabilities.

External Short Message Entities (ESMEs) may provide the ability to maintain a personal distribution list (PDL) and rebroadcast messages to a group. However, services supplied by an external system cannot be managed directly from a handset that lacks internet service. Moreover, external system implementations may add delay and/or complexity, inject additional components subject to failure, and in some cases introduce security, spam, and privacy implications. Additionally, even if rebroadcasting systems were developed and managed within a carrier's network, concerns regarding additional delays and points of failure would remain.

Mobile users want to communicate using text messages with one or more social or business groups. The present inventors have appreciated that there is a need for a method to enable legacy wireless devices to support text-to-group capabilities.

In accordance with the principles of the present invention, a method permitting a legacy device the ability to maintain a personal distribution list (PDL), i.e., a group contact list, comprises the manipulation of text messages sent over the short message service (SMS), with service honed in on the short message service center (SMSC).

A method permitting a communication device to broadcast an SMS message to a personal distribution list (PDL), in accordance with the principles of the present invention, involves use of a personal distribution list (PDL) trigger address. A short message service center (SMSC) utilizes SMS resources, such as the Home Location Register (HLR), to identify a trigger address that indicates a personal distribution list (PDL), located in the destination field of a received SMS message. When a short message service center (SMSC) receives an SMS message destined to a trigger address identifying a personal distribution list (PDL), the short message service center (SMSC) copies the originally transmitted text message for every recipient in the list. The short message service center (SMSC) subsequently routes each duplicate text message to every mobile identification number contained within the indicated personal distribution list (PDL), via conventional SMS procedures.

Additionally, in accordance with another aspect of the present invention, a method permitting a legacy device access to list management capabilities for a personal distribution list (PDL), involves the use of an SMSC Management Code, e.g., the local address of the short message service center (SMSC). The text field of an SMS message, sent from a communication device and addressed to an SMSC Management Code, is parsed by the short message service center (SMSC), to identify a list management operation. List management operations are chosen from a finite number of previously established list management options.

Moreover, in accordance with yet another aspect of the present invention, syntax is established to indicate that the contents of a personal distribution list (PDL) should be synched amongst all devices identified therein. Syntax indicating synchronization, e.g., the keyword ‘SYNC’, is incorporated into an SMS message by a mobile subscriber and transmitted to the short message service center (SMSC) to perform list management. The short message service center (SMSC) parses the text field of a received SMS message and identifies synchronization syntax. Upon identification, the short message service center (SMSC) propagates a copy of the indicated personal distribution list (PDL), as well as all future alterations thereof, to each device identified within the list.

Additionally, in accordance with another aspect of the present invention, list management capabilities pertaining to a personal distribution list (PDL) may also be performed in an out-of-band fashion, via web interface.

The present invention provides a mobile device with full access to one or many personal distribution lists (PDLs) via use of the short message service (SMS), homed on the short message service center (SMSC).

According to the principles of the present invention, list management capabilities, e.g., create, modify, display, delete, and/or send to list, are provided via transmission of SMS messages. Therefore, the present invention provides a device that has access to the short message service (SMS), the ability to maintain and broadcast messages to a personal distribution list (PDL). Accordingly, legacy devices may manage personal distribution lists (PDLs) directly from a mobile handset. The present invention preferably does not require internet access to perform list management operations.

A personal distribution list (PDL) comprises a trigger address. A trigger address, in accordance with the present invention, is a destination address that indicates a personal distribution list (PDL), (as opposed to just a particular mobile device). If a trigger address indicating a personal distribution list (PDL) is located in the destination field of a transmitted SMS message, then the short message service center (SMSC) acts as a proxy to broadcast the content of the mobile originated message to all devices indicated within the referenced personal distribution list (PDL).

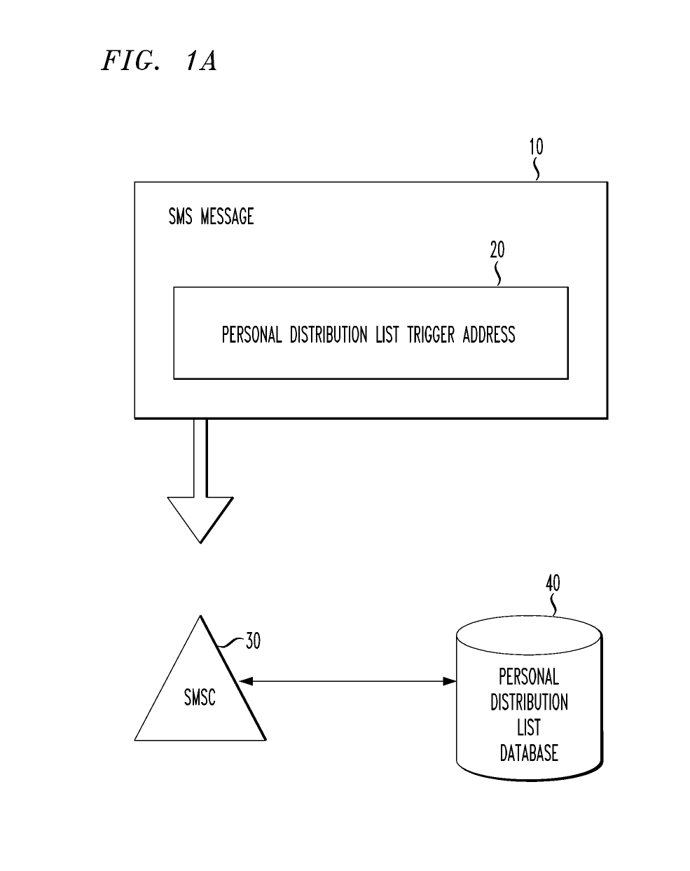

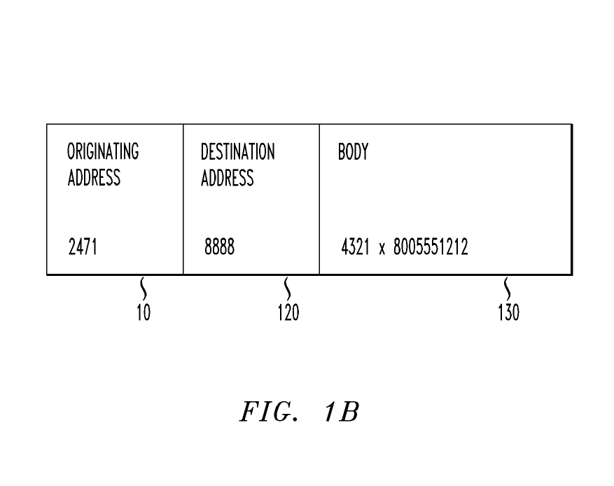

FIG. 1A depicts an exemplary short message flow, in accordance with the principles of the present invention.

An SMS message 10 addressed to a personal distribution list (PDL) is received on the short message service center (SMSC) 30. The short message service center (SMSC) 30 recognizes that the destination portion of the received SMS message 10 contains a personal distribution list (PDL) trigger address 20. Upon identification, the short message service center (SMSC) 30 queries the personal distribution list (PDL) database 40, indicating the particular trigger address 20 designated in the destination portion of the received SMS message 10. The PDL database query returns a list of destination addresses to the short message service center (SMSC) 30. The short message service center (SMSC) 30 subsequently broadcasts the content of the received SMS message 10 to each destination address returned in the PDL database query.

FIG. 1B depicts an illustrative example of the format of a short message, in accordance with the principles of the present invention.

Only those relevant portions of the short message that are necessary to explain the principles of the present invention are shown in FIG. 1B. As depicted in FIG. 1B, a short message may include an originating address 110, a destination address 120, and a data payload 130 containing the content of the short message. The originating address 110 indicates a sender of the SMS message, and the destination address 120 indicates an intended recipient of the SMS message.

A personal distribution list (PDL) is stored on a short message service center (SMSC) or in a database accessible by the short message service center (SMSC) that is serving an originating mobile device.

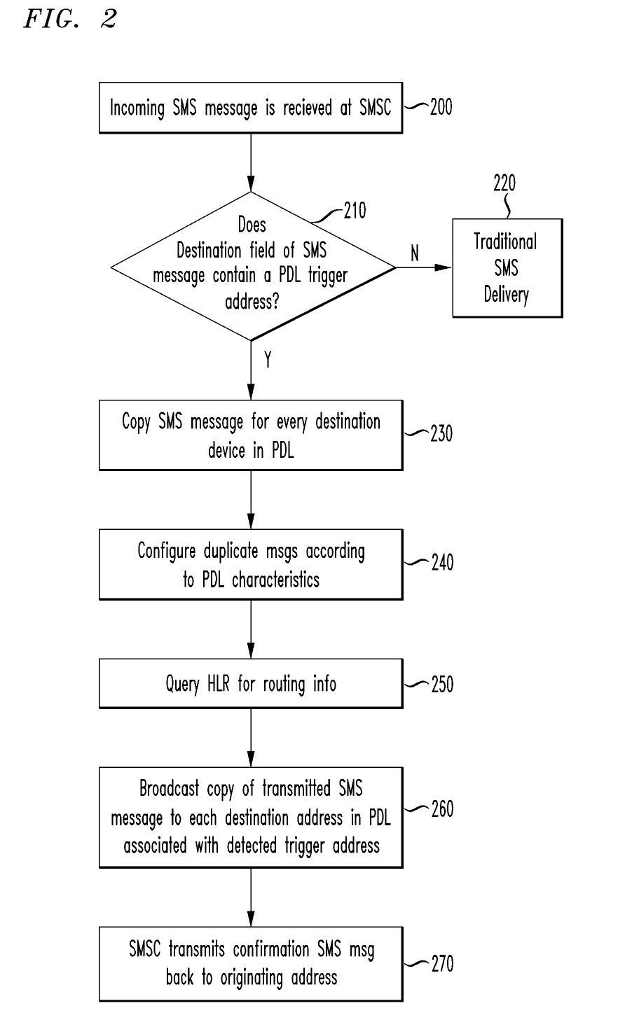

FIG. 2 depicts an exemplary process of broadcasting short messages to a personal distribution list (PDL) via a short message service (SMS), in accordance with the principles of the present invention.

In operation, a single SMS message is addressed to a trigger address indicating a personal distribution list (PDL). In accordance with the conventional short message service (SMS), the SMS message is first routed from a communication device to a short message service center (SMSC) serving the transmitting device, as depicted in step 200. The short message service center (SMSC) parses a message destination field of the received SMS message. In step 210, the short message service center (SMSC) utilizes SMS resources, such as a Home Location Register (HLR) and subscriber profile information stored therein, to recognize if a destination address indicated in the message destination field, pertains to a personal distribution list (PDL). If the message destination field of the recieved message does not contain a trigger address for a personal distribution list (PDL), then the SMS message is transmitted via traditional SMS procedures, as shown in step 220. Otherwise, the short message service center (SMSC) copies the SMS message for each recipient in the designated personal distribution list accessible by the short message service center (SMSC), as depicted in step 230.

Each copied message contains an original message origination address, and is configured in step 240, according to characteristics pertaining to the indicated personal distribution list (PDL). If the indicated personal distribution list (PDL) is configured with a tag, corresponding characters are prepended to the text of the message. A tag informs recipients that an identical SMS message has been transmitted to all devices in the list. If the indicated personal distribution list (PDL) is marked as “SHARED”, a callback number in each copied message is set to the trigger address of the personal distribution list (PDL), so that all replies are also broadcast to the personal distribution list (PDL). This interconnected/meshed implementation of a personal distribution list (PDL) applies primarily to those addresses that are within the carrier's network.

Once the message is configured in step 240, the short message service center (SMSC) proceeds to query the Home Location Register (HLR) for routing information pertaining to each destination address indicated in the personal distribution list (PDL), as shown in step 250. Each copied message is validated and subsequently routed, in accordance with conventional SMS procedures, to appropriate network interfaces for message delivery in step 260. Messages sent to mobile devices located within the carrier's network are delivered, e.g., using CDMA/GSM/LTE technologies. Alternatively, messages routed to an alternate carrier may be routed via an SMPP gateway. SMS messages sent to an email address are delivered via a text to email gateway.

Subsequent to message transmission, a confirmation SMS message is preferably returned to the originating address in step 270, indicating successful transmission, or indicating any destination addresses that failed delivery.

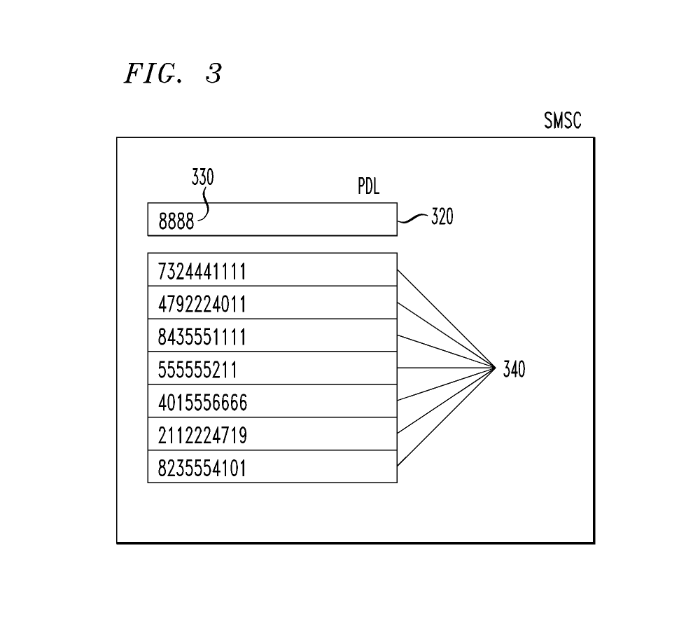

FIG. 3 depicts an illustrative example of a personal distribution list (PDL) maintained in a database accessible by a short message service center (SMSC).

In the example shown in FIG. 3, a trigger address 330 used to identify the depicted personal distribution list (PDL) 320 is, e.g., “8888”. Thus, every time an SMS message is transmitted to trigger address “8888”, the content, or data payload of the transmitted SMS message, is subsequently transmitted to each destination address 340 maintained in the associated personal distribution list (PDL) 320.

If a trigger address is not particularly assigned to the personal distribution list (PDL) 320, then a first destination address indicated in the personal distribution list (PDL) 320 is the trigger address by default.

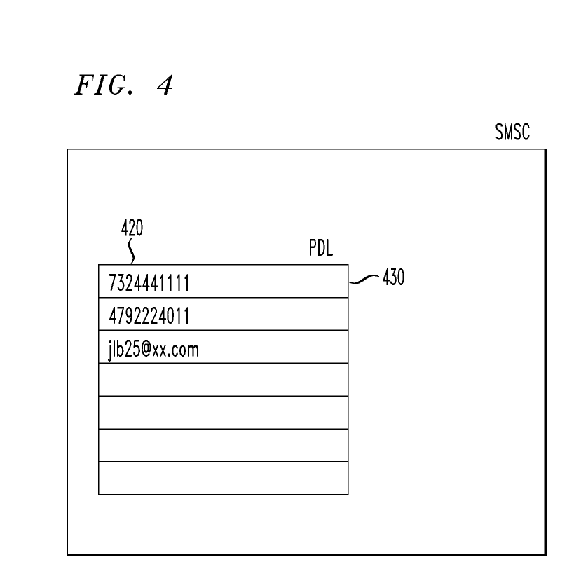

FIG. 4 depicts an illustrative example of a personal distribution list (PDL) with an implied trigger address, in accordance with the principles of the present invention.

For illustrative purposes, FIG. 4 depicts a personal distribution list (PDL) 420 that has not been assigned a trigger address by the originator of the list. A first destination address 430 within the personal distribution list (PDL) 420 is thus an associated trigger address, e.g., “7324441111”, in the personal distribution list (PDL) 420 depicted in FIG. 4.

Destination addresses and trigger addresses may be alphanumeric or numeric within the inventive personal distribution list (PDL). For instance, an SMS message that is addressed to a trigger address, ‘family’, is broadcast to all family members with communication devices indicated within the corresponding personal distribution list (PDL). An alphanumeric trigger address may add additional ease of use to the inventive ‘send to list’ solution. Moreover, alphanumeric addresses are particularly useful when managing multiple personal distribution lists (PDLs). Most trigger addresses will likely be numeric in the present invention, being that the ability to send an SMS message to an alphanumeric address is very much handset dependant. Numeric addresses may also be short codes, unless instructed not to be.

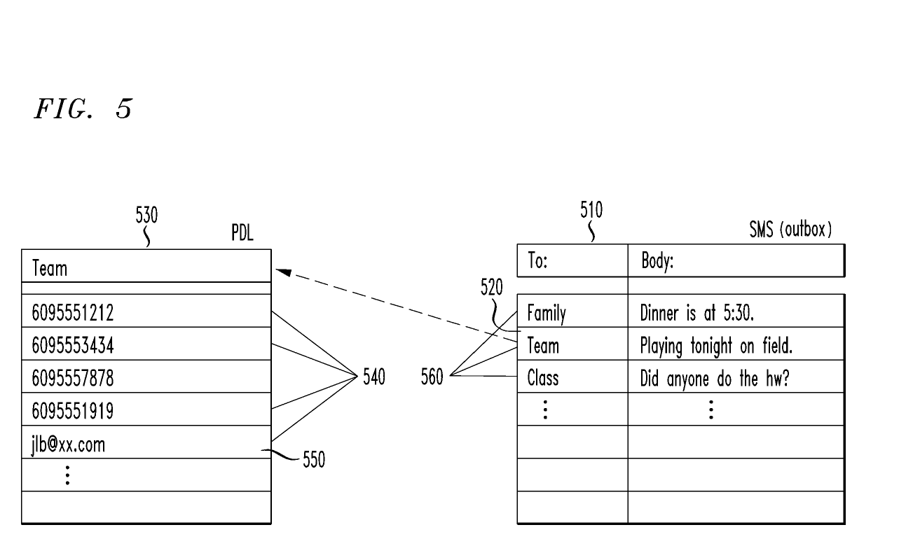

FIG. 5 shows an exemplary outbox of an SMS application implementing the principles of the present invention.

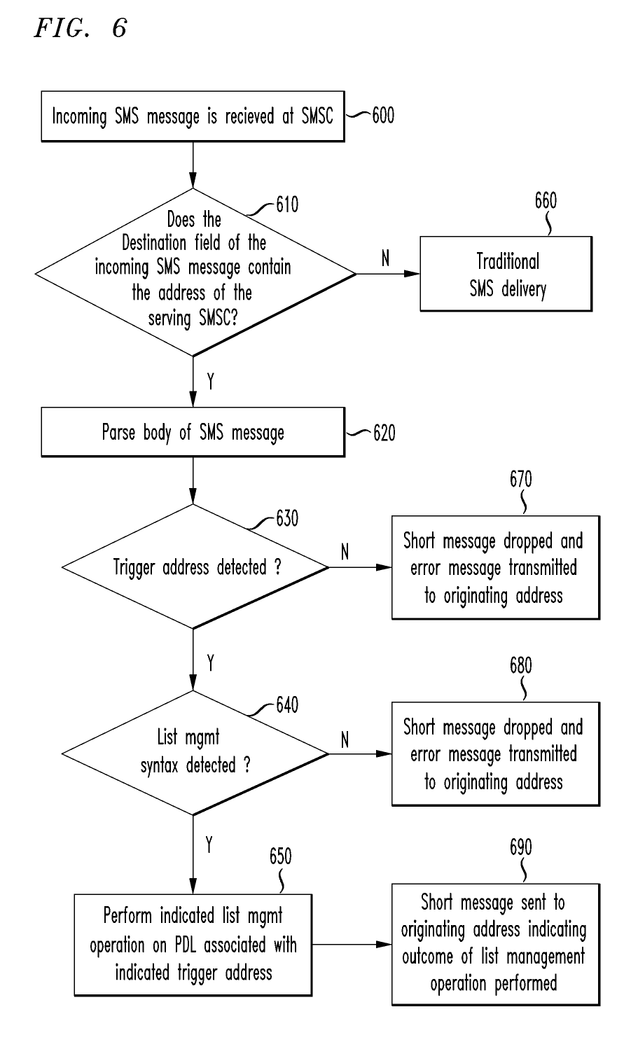

An outbox 510 in FIG. 5 displays messages addressed to alphanumeric trigger addresses 560. For instance, an SMS message addressed to a ‘team’ 520 in FIG. 6, forwards the content of the transmitted SMS message to each team member 540 having a destination address indicated in the personal distribution list (PDL) ‘team’ 530.

Email addresses may be used 550 in a personal distribution list (PDL), as depicted in FIG. 5, to indicate device destination addresses only. A trigger address may not be an email address within the present invention.

List management operations may be performed on a personal distribution list (PDL) so that a subscriber may configure a list via the short message service (SMS).

List management operations are chosen from a finite set of previously determined list management capabilities. List management syntax is expressed using a set of keywords, recognized by the short message service center (SMSC). Syntax indicating list management operations preferably include abbreviations to add, delete, and list entries, and delete and/or tag an entire list, e.g., ‘A’, ‘D’, ‘D LIST’, and ‘T LIST’, respectfully.

The present invention uses an SMSC Management Code, e.g., the local address of the short message service center (SMSC), to enable list management capabilities via transmission of SMS messages.

FIG. 6 depicts an exemplary process of manipulating a personal distribution list (PDL) via the short message service (SMS), in accordance with the principles of the present invention.

In operation, a single SMS message is addressed to the SMSC Management Code, e.g., the local address of the short message service center (SMSC) that is serving the originating device. In accordance with the conventional short message service (SMS), the SMS message is first routed from a communication device to the short message service center (SMSC) serving the transmitting device, as shown in step 600. The short message service center (SMSC) parses the destination field of the received SMS message in step 610. In step 660, if an SMS message is not addressed to the local address of the short message service center (SMSC), as determined in step 610, then the SMS message is transmitted via traditional SMS procedures. Alternatively, if an SMS message received at the short message service center (SMSC) does have a destination address field containing the local address of the short message service center (SMSC), as determined in step 610, then the text field of the transmitted SMS message is parsed in step 620. In step 620, the short message service center (SMSC) parses the SMS message, attempting to identify a trigger address (step 630) corresponding to a personal distribution list (PDL), as well as a list management operation to be performed (step 640).

In step 670, if an SMS message addressed to the SMSC Management Code does not contain a valid trigger address for a personal distribution list (PDL), then the short message service center (SMSC) drops the transmitted SMS message. The short message service center (SMSC) subsequently transmits an SMS message in step 670, indicating the identified error (i.e., the trigger address is invalid or the user is unauthorized to use the referenced personal distribution list (PDL)) to the originating address of the transmitted list management message. One embodiment of the present invention may provide informative error messages, particularly in the case of partial matches or number ordering issues (e.g., “You entered 1243. Did you mean 1234?”). Informative error messages are likely to be of value when customers have access to multiple personal distribution lists (PDLs).

Additionally, in step 680, if a valid trigger address is detected within the body of a personal distribution list (PDL) SMS message in step 630, but valid syntax indicating a list management operation is not present in step 640, then the short message service center (SMSC) drops the transmitted SMS message. The short message service center (SMSC) subsequently transmits an SMS message indicating the identified error (i.e., the list management operation requested is not valid) to the originating subscriber. One embodiment of the present invention may attempt to provide informative error messages (e.g., “You entered ADD. Did you mean to just enter ‘A’?”).

Alternatively, if both a valid trigger address and appropriate list management syntax are detected (in steps 630 and 640) in an SMS message addressed to the SMSC Management Code, e.g., the local address of the short message service center (SMSC), then the requested list management operation (e.g., add, delete, and list entries, delete and/or tag the entire list) is performed on the personal distribution list (PDL) associated with the identified trigger address, as depicted in step 650.

In a preferred embodiment of the present invention, once a list management function is attempted upon a personal distribution list (PDL), a short message indicating the result of the attempted list management operation is transmitted to the originating address in step 690. Yet, this type of functionality (i.e., a confirmation SMS message) is generally configurable. Some operators restrict SMS messages generated by the short message service center (SMSC) due to the pay structure of short messages.

An exemplary SMS message performing list management, as depicted in FIG. 1, may be addressed to, e.g., ‘8888’ 120, a short code indicating the local address of a short message service center (SMSC). The message field 130 of the SMS message contains the text: ‘4321X8005551212’. The number 4321 depicted in FIG. 1, represents a trigger address for a personal distribution list (PDL), ‘X’ represents a list management operation to be performed (e.g., ‘add’, ‘delete’, etc.), and ‘8005551212’ represents a destination address being added, deleted, etc. from personal distribution list (PDL) 4321.

If 4321 is not a valid trigger address for a personal distribution list (PDL), then the exemplary SMS message is dropped by the short message service center (SMSC) and an informative error message is transmitted to the originating address, which is 2471 as depicted in FIG. 1. Alternatively, If 4321 is a valid trigger address for a personal distribution list (PDL), but ‘X’ does not represent a predefined list management operation, then the exemplary SMS message is dropped by the short message service center (SMSC) and an informative error message is transmitted to originating address 2471. Otherwise, if the indicated trigger address, ‘4321’, and list management syntax, ‘X’, are both valid, then the exemplary list management message depicted in FIG. 3 performs function X, e.g. adds or deletes, destination address 8005551212 to/from personal distribution list (PDL) 4321. A confirmation SMS message is then preferably transmitted to 2471, the originating address of the exemplary list management message, depicted in FIG. 1.

Additional text appended to the end of a personal distribution list (PDL) SMS message has no impact on the intended function of the message. Rather, appending additional text to a list management SMS message facilitates a user including notes in the body of the short message (e.g., “4321X8005551212 this is Jane's number”). Extra text is not parsed by the server, yet the user is able to refer back to this text in their outbox for later review.

To add a destination address, an exemplary SMS message performing list management is addressed to ‘8888’, a short code indicating the local address of a short message service center (SMSC). The message field of the SMS message contains the text: ‘4321 A 8005551212’. If all contents are valid, this list management message adds the destination address 8005551212 to personal distribution list (PDL) 4321. A confirmation SMS message is then preferably transmitted to the originating address of this exemplary list management message.

In one preferred embodiment, destination addresses, such as ‘8005551212’, contained in the body of a personal distribution list (PDL) SMS message are not validated upon insertion, but rather validated when the list is actually executed. Thus, an informative error message is returned to an originating address when a particular address fails delivery.

In an alternative preferred embodiment, destination addresses are validated upon attempted insertion in to a personal distribution list (PDL). In this case, if an invalid destination address is requested to be entered in to a personal distribution list (PDL), the SMS message is dropped and an error message is returned to the originating subscriber. In a preferred embodiment, implementation provides informative error messages, e.g., “The number you have listed is for a land-line that cannot receive SMS” or “You entered seven digits, please provide an area code”.

Moreover, if a subscriber sends a short message from a mobile device, requesting to add a destination address to a personal distribution list (PDL), and the number they are requesting to add is already present in the personal distribution list (PDL) they are attempting to add to, then the transmitted short message is dropped and a confirmation message indicating the result of the list management operation is preferably returned to the originating subscriber. The destination address is not added to the indicated personal distribution list (PDL) a second time. Therefore, a personal distribution list (PDL) does not contain duplicate destination addresses. Additionally, the error message returned to the originating address preferably informs the subscriber that the number they are attempting to add is already present in the indicated personal distribution list (PDL).

To delete a destination address, an exemplary list management message is addressed to ‘8888’, a short code indicating the local address of a short message service center (SMSC). The message field of the SMS message contains the text: ‘4321 D 8005551212’. If all contents are valid, this list management message deletes the destination address 8005551212 from personal distribution list (PDL) 4321. A confirmation SMS message is then preferably transmitted to the originating address of this exemplary list management message.

If a user is attempting to delete a destination address from a personal distribution list (PDL), and the number they are attempting to delete is not present in the corresponding personal distribution list (PDL) they are attempting to delete from, then the short message is dropped and an error message is returned to the originating address. In a preferred embodiment, error messages contain additional logic that may provide for partial or number-transposition ‘close’ matches.

To request a listing, an exemplary list management message is addressed to ‘8888’, a short code indicating the local address of a short message service center (SMSC). The message field of the SMS message contains the text: ‘4321 L’. If all contents are valid, an SMS message listing all current entries in personal distribution list (PDL) 4321 is transmitted to the originating address of this exemplary list management message.

To delete a list, an exemplary list management message is addressed to ‘8888’, a short code indicating the local address of a short message service center (SMSC). The message field of the SMS message contains the text: ‘4321 D LIST’. If all contents are valid, this list management message deletes all entries in personal distribution list (PDL) LIST. A confirmation SMS message is then preferably transmitted to the originating address of this exemplary list management message.

To tag a list for a particular group of users, e.g., family, an exemplary list management message is addressed to ‘8888’, a short code indicating the local address of a short message service center (SMSC). The message field of the SMS message contains the text: ‘4321 T FAMILY’. If all contents are valid, this list management message tags personal distribution list (PDL) 4321 with the keyword ‘FAMILY’. A tag informs recipients that an identical SMS message has been transmitted to the entire corresponding distribution list. A confirmation SMS message is then preferably transmitted to the originating address of this exemplary list management message.

Syntax is also established in the present invention, to indicate that the contents of a personal distribution list (PDL) should be synchronized amongst devices identified within the personal distribution list (PDL). The message content of an SMS message addressed to the short message service center (SMSC) is parsed to identify synchronization syntax, e.g., ‘SYNC’ or ‘SHARED’. If a personal distribution list (PDL) SMS message incorporates synchronization syntax, the short message service center (SMSC) propagates a copy of the indicated personal distribution list (PDL), as well as all future modifications thereof, to each device indentified within the referenced personal distribution list (PDL) that is within the carrier's network.

A personal distribution list (PDL) can contain addresses from multiple carriers, serviced by a variety of short message service center (SMSC) vendors. Not all short message service center (SMSC) vendors will have implemented this technology. Thus, users in other carriers receive messages transmitted from a personal distribution list (PDL), but they are not able to fully participate in the shared, i.e., ‘meshed/interconnected’, implementation of the personal distribution list (PDL). Instead, users in alternate carriers respond back to the originator of the message, rather than responding to the personal distribution list (PDL).

Synching a personal distribution list (PDL) triggers a copy of each control message used to manipulate a personal distribution list (PDL), to be transmitted to each destination address in the personal distribution list (PDL) that is within the carrier's network.

To share a list, an exemplary SMS message used to perform list management is addressed to ‘8888’, a short code indicating the local address of a short message service center (SMSC). The SMS message contains the text ‘4321 SHARED’ in the message field. This exemplary SMS message keeps personal distribution list (PDL) 4321 synchronized amongst all members of the list within the carrier's network. Any modification made to the list, by any device indicated within the list, is propagated to each copy of the referenced personal distribution list (PDL).

To share a managed list, an exemplary SMS message used to perform list management is addressed to ‘8888’, a short code indicating the local address of a short message service center (SMSC). The SMS message contains the text ‘4321 SHARED 4105551212’ in the message field. This exemplary SMS message keeps personal distribution list (PDL) 4321 synchronized amongst all members of the list within the carrier's network, but only allows address 4105551212 to manage the list (e.g. perform list management operations upon personal distribution list (PDL) 4321).

A transmitted SMS message initiating an Add/Delete operation on a personal distribution list (PDL) that is SHARED, triggers the transmission of Add/Delete control messages to all addresses in the carrier's network identified within the Shared personal distribution list (SPDL). Rebroadcasted Add/Delete control messages update the indicated Shared personal distribution list (SPDL) on each short message service center (SMSC) within the carrier's network, associated with each destination address contained in the list. Therefore, to assure list synchronization, a list management operation initiated on a Shared personal distribution list (SPDL) triggers the transmission of a copy of the list management operation message to each destination address within the carrier's network that is indicated within the list.

Add/Delete operations initiated on a Shared personal distribution list (SPDL) are terminated with the keyword ‘SYNC’. For instance, an exemplary automated control message is addressed to ‘4444’, a short code indicating the local address of a short message service center (SMSC) affiliated with a device referenced in a recently modified Shared personal distribution list (SPDL). The text field, ‘4322 A 5444232211 SYNC’ indicated in the exemplary control message, adds the destination address 5444232211 to Shared personal distribution list (SPDL) 4322 on short message service center (SMSC) 4444. The short message service center (SMSC) recognizes that a Shared personal distribution list (SPDL) has been modified. List management operations initiated upon a Shared personal distribution list (SPDL) are intended to transmit a copy of the list management operation to each destination address identified in the list. Thus, to avoid facing a looping condition brought about by automated control messages, the keyword ‘SYNC’ is included in the message body. The keyword ‘SYNC’ indicates to the short message service center (SMSC) that the received SMS message is an automated control message, and it is not to be rebroadcast.

Exact syntax may be altered in accordance with the principles of the present invention.

List management may alternatively be performed in an out-of-band fashion via use of a rich web interface. Such an interface updates a personal distribution list (PDL) on the short message service center (SMSC) with which the list is affiliated. This aspect of the present invention provides a subscriber with an additional means of list management, while continuing to preserve the advantages associated with hosting a personal distribution list (PDL) on a short message service center (SMSC), e.g., speed, simplicity, and security. Integration within the short message service center (SMSC) allows a personal distribution list (PDL) to be managed directly from a mobile handset, using the short message service (SMS) and/or through use of a web interface.

In another embodiment, the data within the subscriber's profile may be managed in an out-of-band fashion through any number of means. One implementation is an extension to SMPP Distribution List, but that management is not part of the inventive solution.

Additionally, a message arriving from an External Short Message Entity (ESME) over the Short Message Point to Point (SMPP) protocol (mobile terminated) is not generally expected to trigger a personal distribution list (PDL). A message arriving from an External Short Message Entity (ESME) over the Short Message Point to Point (SMPP) protocol is addressed to a mobile subscriber, rather than a triggering short-code. However, an extension to the present invention is possible, whereby a message arrives with a destination address of a short-code, and the subscriber's address is contained within another designated field. An extension to the invention could use the short code address (or range of addresses) to trigger logic to act as if the subscriber's address from another designated field is in fact the origination address. Then, message transmission may proceed according to principles of the present invention. A use-case for this type of behavior is not seen at this time, but the possibility of implementing support for this flow is contemplated for a future extension.

The present invention has the capability and potential to increase value proposition for wireless carriers, as they are enabled to offer a distinguishing SMS feature to their subscribers. Moreover, the present invention increases SMS traffic for a carrier, and therefore drives up revenue. The invention also enables reductions in carrier cost and complexity, as opposed to the creation of a stand-alone system, independent of the short message service center (SMSC), to perform similar functionality.

The present invention may be used to provide equipment and services relating to subscriber SMS personal distribution lists (PDLs), as well as to short message service centers (SMSCs) that provide reserved shortcodes for subscribers to use for their personal distribution lists (PDLs). Subscribers can mobile originate messages to their provisioned groups (e.g., family, sports team, etc.) using a specific shortcode.

The invention has particular applicability to wireless carriers particularly regardless of air interface: LTE/CDMA/GSM, or any combination thereof.

While the invention has been described with reference to the exemplary embodiments thereof, those skilled in the art will be able to make various modifications to the described embodiments of the invention without departing from the true spirit and scope of the invention.

What is claimed is:

1. A personal distribution list (PDL) distributor for a short message service center (SMSC), comprising:
a trigger module, triggered by detection of a specific trigger address contained within a received short message, to identify a predefined personal distribution list (PDL) predefined within a personal distribution list database accessible to a short message service center (SMSC);
a message duplicator module to copy said received short message for each unique destination address within said identified personal distribution list to a plurality of uniquely destination-addressed short messages each containing a same payload; and
a transmitter to transmit each of said plurality of uniquely destination-addressed short messages to respective destinations.

2. The personal distribution list (PDL) distributor for a short message service center (SMSC) according to claim 1, wherein:
said trigger address is a short code.

3. The personal distribution list (PDL) distributor for a short message service center (SMSC) according to claim 1, wherein:
said trigger address is an SMS dialed number.

4. The personal distribution list (PDL) distributor for a short message service center (SMSC) according to claim 1, wherein:
said trigger address is user-defined.

5. The personal distribution list (PDL) distributor for a short message service center (SMSC) according to claim 1, wherein:
said trigger address is a first destination address referenced in said personal distribution list (PDL).

6. The personal distribution list (PDL) distributor for a short message service center (SMSC) according to claim 1, wherein a destination address in each of said plurality of uniquely destination-addressed short messages comprises at least one of:
an alphanumeric short code;
a numeric short code;
an SMS dialed number; and
an email address.

7. A method of broadcasting a single SMS message to a plurality of destinations, comprising:
receiving an SMS message addressed to a unique destination address associated with a desired personal distribution list;
duplicating said received SMS message for each of a plurality of destination addresses predefined in said desired personal distribution list;
configuring each duplicate SMS message according to a configuration characteristic predefined within said desired personal distribution list (PDL);
routing each duplicate SMS message toward respective destinations using respective protocols predefined in said desired personal distribution list (PDL);

8. The method of broadcasting a single SMS message to a plurality of destinations according to claim 7, further comprising:
transmitting a confirmation SMS message to an originating address of said received SMS message.

9. The method of broadcasting a single SMS message to a plurality of destinations according to claim 7, wherein:
each said duplicate SMS message is configured with an original message origination address.

10. The method of broadcasting a single SMS message to a plurality of destinations according to claim 7, wherein:
each said duplicate message is configured with a tag.

11. The method of broadcasting a single SMS message to a plurality of destinations according to claim 7, wherein:
said confirmation SMS message is configured with clarifying information.

12. The method of broadcasting a single SMS message to a plurality of destinations according to claim 7, wherein:
said plurality of duplicate messages are transmitted using at least two different communication protocols.

13. A short message service center (SMSC) to broadcast a single received SMS message to a plurality of destinations predefined in a personal distribution list (PDL), comprising:
a receiver to receive an SMS message addressed to a personal distribution list (PDL);
a duplicator to copy said received SMS message for each of a plurality of unique destination addresses predefined in said personal distribution list (PDL);
a configuration module to configure each duplicate message according to respective configuration characteristics predefined in said personal distribution list (PDL); and
a transmitter to transmit each duplicate message to each respective destination address.

14. The short message service center (SMSC) to broadcast a single received SMS message to a plurality of destinations predefined in a personal distribution list (PDL) according to claim 13, further comprising:
a transmitter to transmit a confirmation SMS message to an originating address of said received SMS message.

15. A method of performing list management on a personal distribution list (PDL), comprising:
receiving an SMS message addressed to an SMSC Management Code;
parsing a text field of said received SMS message for a valid personal distribution list (PDL) trigger address;
parsing said text field of said received SMS message for predefined list management syntax;
performing an appropriate list management operation on an indicated personal distribution list (PDL) upon validation of said PDL trigger address, and identification of said predefined list management syntax contained within said received SMS message;
transmitting a confirmation SMS message to an originating address.

16. The method of performing list management on a personal distribution list (PDL) according to claim 15, wherein:
said SMSC Management Code is a local address of a short message service center (SMSC).

17. The method of performing list management on a personal distribution list (PDL) according to claim 15, wherein said performing said appropriate list management operation comprises at least one of:
adding a destination address;
deleting a destination address;
listing entries;
deleting list;
tagging list; and
sharing list.

18. The method of performing list management on a personal distribution list (PDL) according to claim 15, wherein said list management syntax further comprises:
synchronization syntax to synchronize said personal distribution list (PDL) amongst all devices within said designated personal distribution list (PDL) that are also within a carrier's network, to create a shared personal distribution list (SPDL).

19. The method of performing list management on a personal distribution list (PDL) according to claim 18, wherein:
said synchronization syntax propagates a copy of said personal distribution list (PDL) to each destination address contained in said personal distribution list (PDL); and
an automated control message is transmitted to each destination address indicated in said personal distribution list (PDL) for every list management operation performed upon said shared personal distribution list (SPDL).

20. The method of performing list management on a personal distribution list (PDL) according to claim 15, wherein:
said confirmation SMS message is configured with informative clarifying information.

21. A short message service center (SMSC) to perform list management on a personal distribution list (PDL), comprising:
a receiver to receive an SMS message addressed to an SMSC Management Code;
a parser to parse said SMS message for identification of a valid trigger address associated with predefined list management syntax;
a list manager to perform a list management operation requested in said received SMS message; and
a transmitter to transmit a confirmation SMS message to an originating address of said received SMS message.

22. A method of performing list management on a personal distribution list (PDL), according to claim 21, wherein:
said list management is performed via a rich web interface.
